(19) United States
(12) Patent Application Publication
(10) Pub. No.: US 2011/0297714 A1
(43) Pub. Date: Dec. 8, 2011

(54) Vehicle Accessory Holder

(76) Inventor: Ronald Dean Freeman, Indianapolis, IN (US)

(21) Appl. No.: 12/791,902

(22) Filed: Jun. 2, 2010

(51) Int. Cl. B60R 7/06

(52) U.S. Cl. 224/483

(57) ABSTRACT

A vehicle accessory holder having several accessory receptacles defining several accessory retention compartments is provided for retaining various accessories or items such as sunglasses, cell phones, business cards, paper and pens/pencils, lottery tickets and the like proximate to the vehicle driver. The vehicle accessory holder is attached to the vehicle's rear view mirror mount and is adjustable in position relative to the driver in all directions within the vehicle. A flexible hanger that bends but retains its shape is attached to the receptacles via a clamp that allows easy and quick up/down height adjustment of the receptacles along the hanger to vertically position the receptacles relative to the rear view mirror. Two hooks on automatically retractable cords are positioned on both sides of the receptacles to provide attachment to air vents or other structures of the vehicle. The automatic retraction of the cords provides retention of the receptacles against the center console of the vehicle.

### BACKGROUND OF THE INVENTION

1. Field of the Invention

The present invention relates to devices that are used in vehicles for holding personal accessories and other items and, more particularly, to an adjustably positionable device for holding a plurality of accessories and items within reach of a driver in the interior of a vehicle.

2. Background Information

In today's world, drivers of vehicles usually have a variety of personal accessories that they may occasionally use while driving or may just want to carry with them. Typical accessories include sunglasses, cell phones, digital music players and the like. Additionally, the driver may have or accumulate small items such as coins, lottery tickets, keys, writing and/or marking instruments, writing pads, business cards and the like that the driver wants or needs to be stored within the vehicle. It is usually desired to keep these accessories and items handy. Because most automobiles lack specific accommodations for small items and typical accessories, they are usually stored in the glove box, center console, cup holder(s), ash tray, side door pockets or other places within the automobile.

These storage places, however, are not designed to adequately or effectively hold such accessories or items. Moreover, these storage places are typically not within easy reach of the automobile driver and thus do not allow easy access to the accessories or items while driving. These factors thus make it quite difficult for the driver to access the desired items and/or accessories for use while driving without causing driver distraction. Moreover, if the particular storage place is being used to hold its intended cargo, for example a cup in a cup holder, there may be no room for the item or accessory.

In view of the above, various prior art devices have attempted to overcome these problems and/or deficiencies. These devices can be categorized according to their solution and/or use. For instance, various patents such as U.S. Pat. Nos. 5,971,242 to Schuerman, 5,179,590 to Wang, 5,086,958 and 5,048,733 to Nagy, and 4,877,164 to Baucom, all disclose devices that plug into the typical automobile accessory outlet and hold a specific type of accessory or item. The drawback is that these devices only hold one accessory or item. Furthermore, these devices put stress on the accessory outlet by projecting far away from the accessory outlet. They are also not able or suited to hold a variety of items or accessories.

Another single item holder is provided in U.S. Pat. No. 4,576,320 to Mead. Mead discloses an eyeglass holder for use in conjunction with a rear view mirror of an automobile. The eyeglass holder includes suction cups, each attached to adjustable length stems that extend from the eyeglass holder body. The suction cups are for adhering to the windshield of the automobile for stabilizing the eyeglass holder body. Hook members may be provided that are adapted to engage the upper and lower ends of the rear view mirror. Because of its design, glasses or any other item held in the Mead device is not easily reachable during driving. Moreover, Mead cannot hold multiple items or accessories, nor is it adjustable with respect to the driver.

U.S. Pat. Nos. 1,656,339 to Runyan and 3,014,759 to Bing, disclose automobile item receptacles that are configured to hold various articles or packages. While these devices are not made for any one specific item and thus can hold a variety of items, they are designed to be suspended or otherwise attached to the rear of one of the front seats of the automobile. This makes it difficult, if not impossible for the driver to store or retrieve an item from the receptacle. U.S. Pat. No. 5,803,325 to Wang alleviates this problem by a multifunctional article holder that is adapted to rest between the two front seats of an automobile. The Wang holder has a main body defining a main holding compartment and a plurality of supplementary holding compartments. A plurality of latch clips are attached to the main body and adapted to secure the main body to the front seats. However, with today's automobile designs there is usually no open room between the front seats. Instead, a console is provided between the two front seats, making the Wang multifunctional article holder obsolete.

It is evident from the above that the prior art does not disclose a device for a vehicle that can hold a plurality of items or accessories within easy reach of the driver. It is also evident that the prior art does not disclose a device for a vehicle that can hold a plurality of items or accessories within easy reach of the driver by allowing easy positional adjustment of its position relative to the driver within the vehicle.

### SUMMARY OF THE INVENTION

The present invention is a vehicle accessory and/or item holder for retaining various accessories or items proximate to a driver of a vehicle. The vehicle accessory holder is attached to the vehicle's rear view mirror mount and is adjustable in position relative to the driver in all directions within the vehicle. The vehicle accessory holder has one or more accessory receptacles defining one or more accessory retention compartments that are configured to hold sunglasses, cell phones, business cards, paper and pens/pencils, lottery tickets and the like.

A flexible hanger that bends but retains its shape is attached to the receptacle(s) via a clamp that allows easy and quick up/down height adjustment of the receptacle(s) along the hanger to vertically position the receptacles relative to the rear view mirror. Auxiliary attachment devices provide lateral positioning of the receptacle(s) relative to the center console of the vehicle.

In one form, each auxiliary attachment device includes a hook on an automatically retractable cord to provide attachment thereof to an air vent or other structure of the vehicle. The automatic retraction of the cords provides retention of the receptacle(s) against the center console of the vehicle.

The present vehicle accessory holder provides the benefits of keeping various accessories within safe and easy reach of the driver; therefore, no more lost, scratched or broken sunglasses, cell phones or other items. Moreover, the flex-adjust design of the present vehicle accessory holder allows installation and use in any vehicle.

The more important features and benefits of the invention have been outlined rather broadly in order that the detailed description thereof that follows may be better understood, and in order that the present contribution to the art may be better appreciated. There are, of course additional features of the invention that will be described hereinafter and which may form the subject matter of claims appended hereto. Those skilled in the art will appreciate the concept upon which this disclosure is based, and may readily be utilized as a basis for designing other structures, methods and systems for carrying out the purposes of the present invention. It is important, therefore, that the claims be regarded as including such equivalent constructions insofar as they do not depart from the spirit and scope of the present invention.

These, together with objects of the invention, along with the various features of novelty which characterize the invention, are pointed out with particularity in the following description and claims annexed to and forming a part of this disclosure. For a better understanding of the invention, its operating advantages and the specific objects attained by its uses, reference should be had to the accompanying drawings and descriptive matter in which there are illustrated a preferred embodiment of the invention.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a side front perspective view of a vehicle accessory holder fashioned in accordance with the present principles;

FIG. 2 is a side rear perspective view of the vehicle accessory holder of FIG. 1;

FIG. 3 is a rear perspective view of the vehicle accessory holder of FIG. 1;

FIG. 4 is a side top perspective view of the vehicle accessory holder of FIG. 1; and

FIG. 5 is a partial perspective view of a driver's side area of an automobile with the present vehicle accessory holder installed therein.

Like reference numerals indicate the same or similar parts throughout the several figures.

### DETAILED DESCRIPTION OF THE PREFERRED EMBODIMENTS

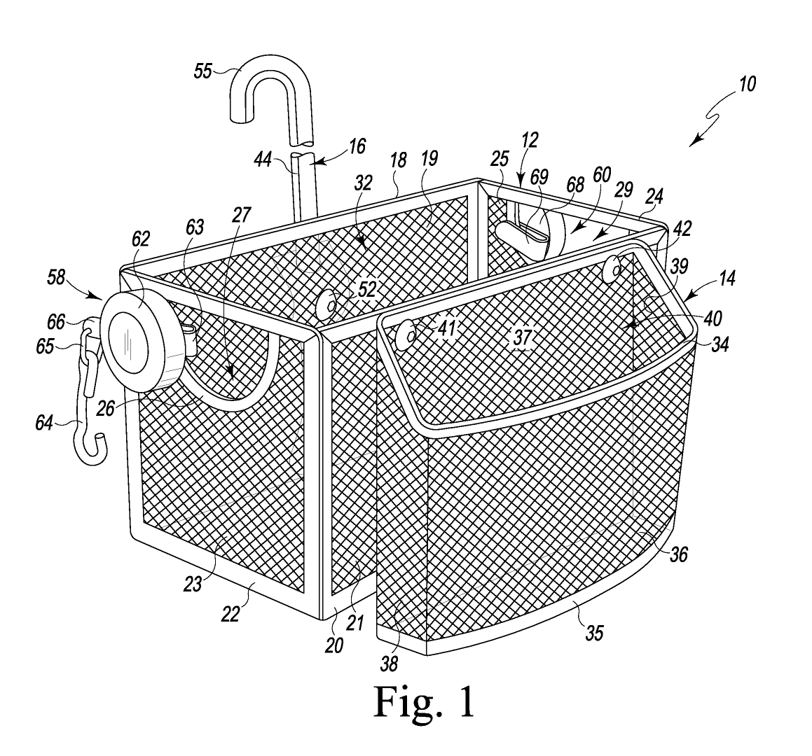

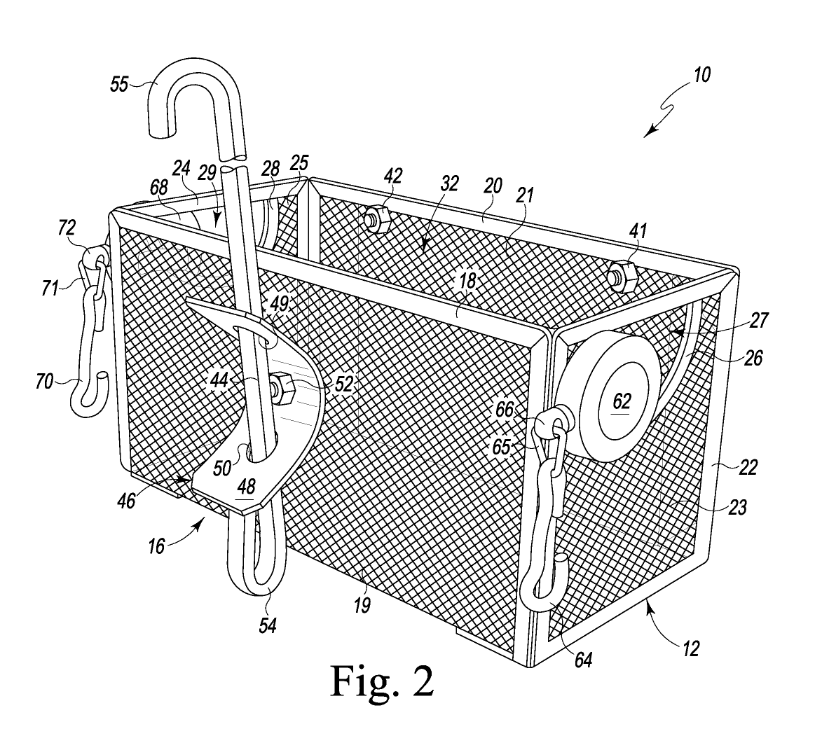

Referring to FIGS. 1-4, there is depicted various views of a vehicle accessory holder, generally designated 10, fashioned in accordance with the present principles. The vehicle accessory holder 10 is configured to hold, retain or allow the attachment to of a plurality of accessories or items proximate to and within easy reach of the vehicle driver. Additionally, in accordance with the present principles, the position of the vehicle accessory holder 10 relative to the driver of the vehicle is adjustable. It should be understood that the term vehicle encompasses all types of motor vehicles (e.g. automobiles, trucks, buses, etc.) so that the vehicle accessory holder 10 may be used in all types of vehicles.

The vehicle accessory holder 10 has a first or main receptacle 12 formed as a generally open, rectangular box and a second or secondary receptacle 14 formed as an open, generally basket-shaped box that is attached, connected, affixed, fastened or otherwise formed with or onto the front of the first receptacle 12. It should be appreciated that the nomenclature first and second is arbitrary. Also, it should be appreciated that the general configuration of the first and second receptacles 12, 14 may be changed as desired. Additionally, the vehicle accessory holder 10 may include more than two compartments.

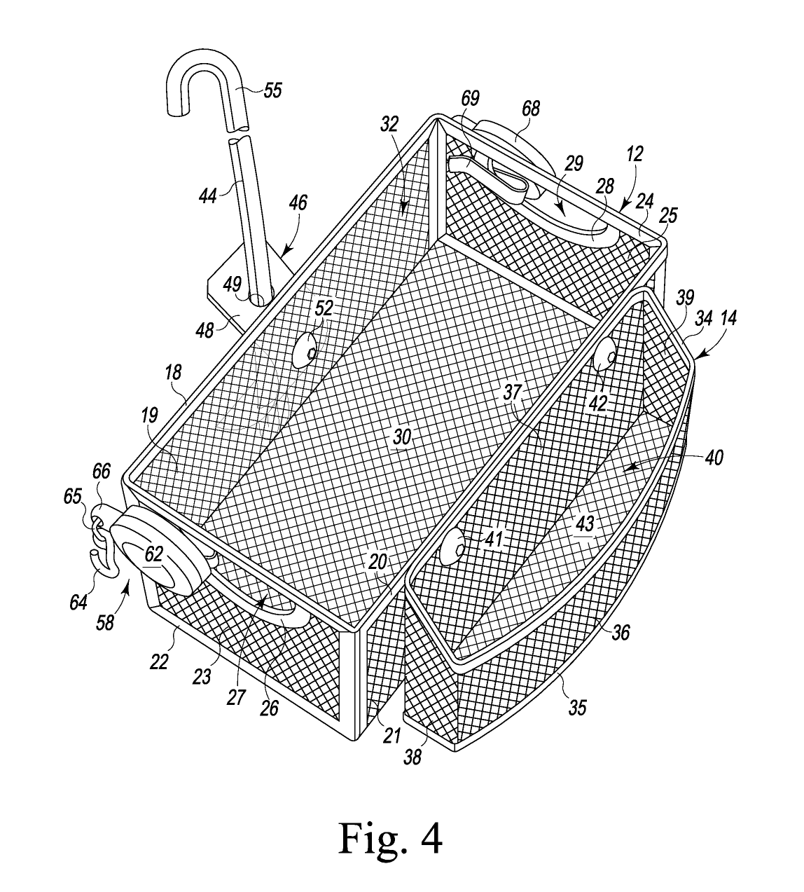

The first receptacle 12 is defined by a rear rectangular frame 18 holding or supporting a rear rectangular wall, face, surface or the like (collectively and hereinafter, wall) 19, a front rectangular frame 20 holding or supporting a front rectangular wall, face, surface or the like (collectively and hereinafter, wall) 21, a first side rectangular frame 22 holding or supporting a first side rectangular wall, face, surface or the like (hereinafter, wall) 23, and a second side rectangular frame 24 holding or supporting a second side rectangular wall, face, surface or the like (hereinafter, wall) 25. It should be appreciated that the nomenclature rear, front, first and second is arbitrary. A rectangular bottom surface 30 (see FIG. 4) is provided laterally between the front, rear, and first and second side walls 21, 19, 23 and 25.

The frames 18, 20, 22 and 24 are made of metal, plastic or other suitable material. The walls 19, 21, 23 and 25 and bottom surface 30 are shown as being formed of a mesh but may be solid if desired. Mesh, however, provides the ability for the driver to see into the first receptacle 12. As an alternative, the walls 19, 21, 23 and 25 may be part solid, part mesh. Other variations are envisioned. In like manner to the frames 18, 20, 22 and 24, the walls 19, 21, 23 and 25 are made of metal, plastic or other suitable material. A first or main interior or compartment 32 is formed by the connection of the frames 18, 20, 22, 24, the walls 19, 21, 23, 25 and the bottom 43.

The first compartment 32 is sized to accommodate a pair of sunglasses (not shown) and other large items. Size of the first compartment 32 may differ as desired. It should also be appreciated that the first compartment 32 may be sectioned if desired in order to provide or form two or more compartments. The walls of the sections may be mesh, solid or a combination of mesh and solid in like manner to the walls 19, 21, 23 and 25 of the first receptacle 12 and formed of the same or similar material.

The second receptacle 14 is defined by a continuous upper frame 34 and a lower frame 35 holding or supporting a rear rectangular wall, face, surface or the like (collectively and hereinafter, wall) 37, a front generally curved rectangular wall, face, surface or the like (collectively and hereinafter, wall) 36, a first side rectangular wall, face, surface or the like (collectively and hereinafter, wall) 38, and side rectangular wall, face, surface or the like (collectively and hereinafter, wall) 39. It should be appreciated that the nomenclature rear, front, first and second is arbitrary. A rectangular bottom surface 43 (see FIG. 4) is provided laterally between the front, rear, and first and second side walls 36, 37, 38 and 39.

The frames 34 and 35 are made of metal, plastic or other suitable material. The walls 36, 37, 38 and 39 and bottom surface 43 are shown as being formed of a mesh but may be solid if desired. Mesh, however, provides the ability for the driver to see into the second receptacle 14. As an alternative, the walls 36, 37, 38 and 39 may be part solid, part mesh. Other variations are envisioned. In like manner to the frames 34 and 35, the walls 36, 37, 38 and 39 are made of metal, plastic or other suitable material. A second or secondary interior or compartment 40 is formed by the connection of the frames 34, 35, the walls 36, 37, 38 and 39, and the bottom 43.

The second receptacle 14 is smaller in size than the first receptacle 12 and is generally in the shape of a somewhat flattened creel. Thus, the second compartment 40 is narrower than the first compartment 32 and therefore sized to accommodate thinner devices, accessories or items than the first compartment 32. Size of the second receptacle 14 and thus the second compartment 40 may differ as desired. It should also be appreciated that the second compartment 40 may be sectioned if desired in order to provide or form two or more compartments. The walls of the sections may be mesh, solid or a combination of mesh and solid in like manner to the walls 36, 37, 38 and 39 of the second receptacle 14 and formed of the same or similar material.

The second receptacle 14 is attached, fixed or connected to the first receptacle 12 by first and second fasteners 41, 42. The fasteners 41, 42 may be rivets, bolts with nuts (as shown), screws or other type of fastener. Instead of a fastener, the second receptacle 14 may be formed with or be part of the first receptacle 12. Likewise, the second receptacle 14 may be a compartment of the first receptacle 12. It should be appreciated that the present vehicle accessory holder 10 may have any number of receptacles.

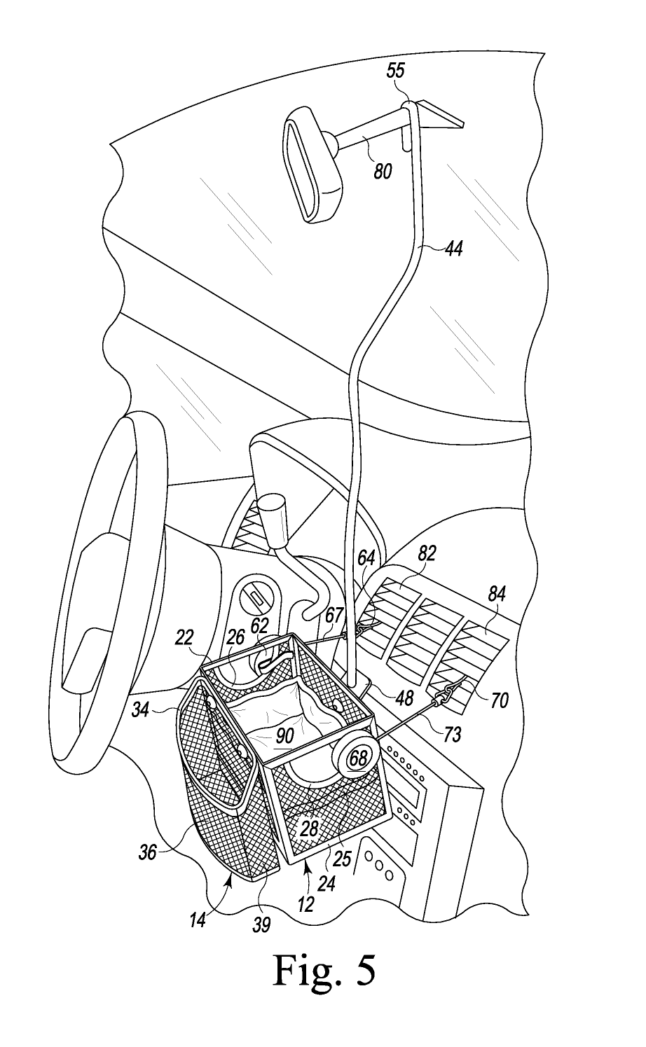

The vehicle accessory holder 10 has an attachment portion 16 for hanging the first and second receptacles 12, 14 in a vehicle and particularly, but not necessarily, from the rear view mirror mount of a vehicle. The attachment portion 16 includes a flexible rod, shaft or the like (collectively and hereinafter, flexible rod) 44 that can be bent into and retain a particular shape. This allows flexibility in positioning the first and second receptacles 12, 14 within the vehicle. A first or upper end of the flexible rod 44 is fashioned into a hook 55 that is adapted to attach to the vehicle's rear view mirror mount (see FIG. 5). The flexible rod 44 extends through a connection and adjustment structure 46 that is connected to the first receptacle 12. Particularly, a bolt and nut (fastener) 52 connects the connection and adjustment structure 46 to the rear wall 19 of the first receptacle 12. It should be appreciated that other types of fasteners may be used if desired.

The connection and adjustment structure 46 is defined by a strap 48 made from a resilient or spring-like material. The strap 48 has a first or upper aperture 49 and a second or lower aperture 50 with the flexible rod 44 extending through the upper and lower apertures 49, 50. A second or lower end of the flexible rod 44 is fashioned into a hook 54 to prevent the flexible rod 44 from coming out of the strap 48. The hook 54 also provides a stop defining a lower most adjustment position of the first and second receptacles 12, 14 relative to the flexible rod 44.

The position of the first and second receptacles 12, 14 on or relative to the flexible rod 44 is adjusted by manipulation of the strap 48. Because the strap 48 is resilient, it has a natural bias that causes the strap 48 to want to be flat or planar. Thus, when the strap 48 is bent to accommodate the flexible rod 44 extending through its upper and lower apertures 49, 50 the strap 48 exerts an upward and inward force or bias against the flexible rod 44 at the upper aperture 49, and a downward and inward force or bias against the flexible rod 44 at the lower aperture 50. This biasing holds the strap 48 against and onto the flexible rod 44 to hold the position of the first and second receptacles 12, 14 on and relative to the flexible rod 44. In order to change or adjust the position of the first and second receptacles 12, 14 on and relative to the flexible rod 44 (i.e. up and down the flexible rod 44), the upper and lower ends of the strap 48 (proximate the upper and lower apertures 49, 50) are pinched or squeezed together thereby releasing the strap holding bias and allowing the flexible rod 44 to slide up and down through the upper and lower apertures 49, 50 (i.e. relative to the strap 48).

As best seen in FIGS. 1, 2 and 4, the first receptacle 12 has a first opening 27, defined by a first opening frame 26, in an upper portion of the first side wall 23 adjacent an upper portion of the first side frame 22. The first opening frame 26 extends in an arc from one side of the upper portion of the first side frame 22 to another side of the upper portion of the first side frame 22 to define a generally half-circular opening 27. The first receptacle 12 also has a second opening 29, defined by a second opening frame 28, in an upper portion of the second side wall 25 adjacent an upper portion of the second side frame 24. The second opening frame 28 extends in an arc from one side of the upper portion of the second side frame 24 to another side of the upper portion of the second side frame 24 to define a generally half-circular opening 29.

The vehicle accessory holder 10 further includes first and second supplementary attachment devices 58 and 60 that also may be referred to as receptacle stabilization devices in that the first and second supplementary attachment devices 58 and 60 provide lateral stabilization of the first and second receptacles 12, 14 within the vehicle. Particularly, and as shown in FIG. 5, the first and second supplementary attachment devices 58, 60 allow tensioned coupling of the lateral sides of the first receptacle 12 to air vents (or other structures) of the vehicle. Thus, the first and second supplementary attachment devices 58, 60 pull the lateral sides of the first receptacle 12 towards the center console of the vehicle.

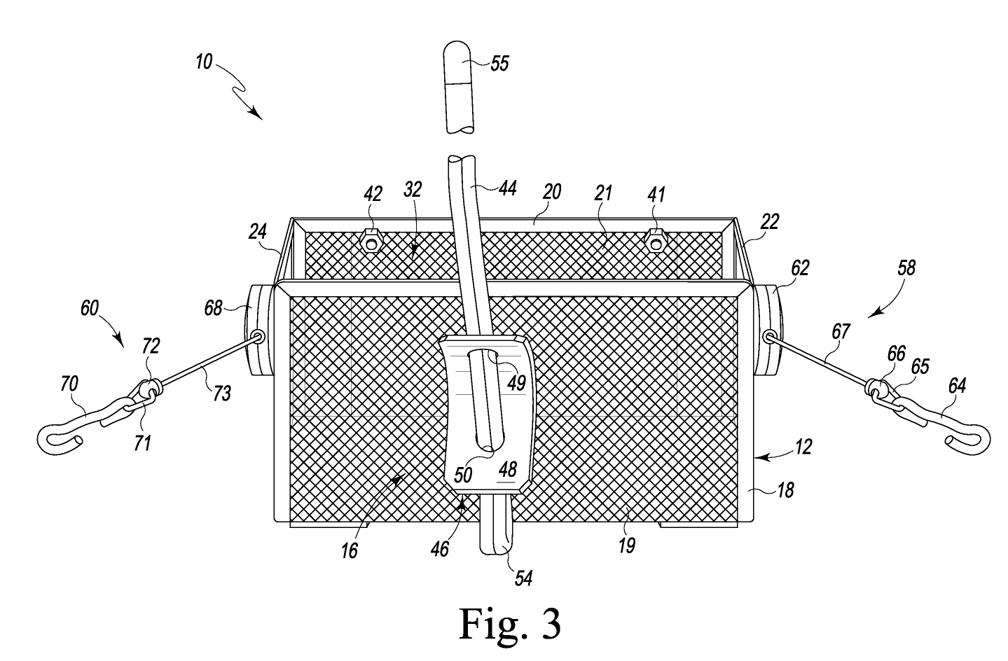

The first supplementary attachment device 58 is characterized by a spool 62 that is attached through the first opening 27 and onto the first opening frame 26 via a clip 63. Attachment of the spool 62 via the clip 63 allows positionable adjustment of the spool 62 relative to the first receptacle 12. The spool 62 contains an automatic retraction or tensioning mechanism (not seen) having a cord, line or the like (collectively and hereinafter, cord) 67 attached thereto (see FIG. 3) that automatically tends to pull the cord 67 back into the spool 62. The line 67 extends from an opening in the spool 62 and terminates outside of the spool 62 in a head 66. The head 66 is sized such that when the cord 67 is retracted into the spool 62 (see, e.g. FIGS. 1 and 4), the head 66 remains on the outside of the spool 62. The head 66 preferably, but not necessarily, swivels with respect to the cord 67. A hook 64 is connected to the head 66 via a triangle coupling 65. The hook 64 is configured to allow attachment thereof to an air vent on the center console of a vehicle. It should be appreciated that the hook 64 may be attached to another structure on the center console. Moreover, another type of connector may be used instead of the hook 64.

The second supplementary attachment device 60 is characterized by a spool 68 that is attached through the second opening 29 and onto the second opening frame 29 via a clip 69. Attachment of the spool 68 via the clip 68 allows positionable adjustment of the spool 68 relative to the first receptacle 12. The spool 68 contains an automatic retraction or tensioning mechanism (not seen) having a cord, line or the like (collectively and hereinafter, cord) 73 attached thereto (see FIG. 3) that automatically tends to pull the cord 73 back into the spool 68. The line 73 extends from an opening in the spool 68 and terminates outside of the spool 68 in a head 72. The head 72 is sized such that when the cord 73 is retracted into the spool 68 (see, e.g. FIGS. 1 and 4), the head 72 remains on the outside of the spool 68. The head 72 preferably, but not necessarily, swivels with respect to the cord 73. A hook 70 is connected to the head 72 via a triangle coupling 71. The hook 70 is configured to allow attachment thereof to an air vent on the center console of a vehicle. It should be appreciated that the hook 70 may be attached to another structure on the center console. Moreover, another type of connector may be used instead of the hook 70.

Referring now to FIG. 5, the vehicle accessory holder 10 is shown installed in an automobile. It should be appreciated that while the present vehicle accessory holder 10 is shown in and with respect to an automobile, it may be used in any vehicle. The upper hook 55 of the flexible rod 44 is attached onto the mount 80 of the rear view mirror of the vehicle. The vertical height of the receptacles 12, 14 relative to the flexible rod 44 is adjusted as described above, and the flexible rod 44 is bent accordingly in order to position the receptacles 12, 14 in a desired position. The hook 64 of the first supplementary attachment device 58 is connected to a first set of air vents 82 of the center console of the vehicle, while the second hook 70 of the second supplementary attachment device 60 is connected to a second set of air vents 84 of the center console of the vehicle. The tensioned cords 67 and 73 of the first and second supplementary attachment devices 58, 60 pull the first and second receptacles 12, 14 towards the center console. In this manner, the vehicle accessory holder 10 is in a position proximate to the driver such that the driver can easily reach, obtain and/or store any item or accessory in the vehicle accessory holder 10.

As shown in FIG. 5, a pad, cloth or other type of liner (collectively and hereinafter, liner) 90 of a suitably soft and preferably pliable material, may optionally be situated in the main compartment 32. The liner 90 provides cushioning for items and/or accessories such as sunglasses and the like. While not shown, a liner may be situated in the secondary compartment 40 if desired.

While the invention has been illustrated and described in detail in the drawings and foregoing description, the same is to be considered as illustrative and not restrictive in character, it being understood that a preferred embodiment has been shown and described and that all changes and modifications that come within the spirit of the invention are desired to be protected.

What is claimed is:

1. A device for holding various accessories or items within a vehicle and proximate to a driver of the vehicle, the device comprising:
a first receptacle defining a first compartment for holding accessories or items;
a rod made from a bendable and shape-retainable material, the rod having a first hook on an upper end thereof that is connectable to a rear view mirror mount of the vehicle; and
a connector attached to the first receptacle and to the rod so as to allow adjustable movement of the rod relative to the connector to change position of the first receptacle relative to the rod.

2. The device of claim 1, wherein the connector comprises a biasing member that is naturally biased into a holding position with respect to the rod and which, when unbiased through manual manipulation, allows the movement of the rod relative to the biasing member.

3. The device of claim 2, wherein the biasing member comprises a strap made from a resilient material and having an upper aperture and a lower aperture, the strap connected to a rear wall of the first receptacle at a point between the first and second apertures, the rod extending through the upper and lower apertures.

4. The device of claim 3, wherein the rod further has a second hook on a lower end thereof that is below the second aperture of the strap, the second hook preventing the rod from coming free of the strap.

5. The device of claim 1, further comprising:
a first lateral stabilizer associated with a first lateral side of the first receptacle and providing tensioned connection of the first lateral side of the first receptacle to a first structure of a center console of the vehicle; and
a second stabilizer associated with a second lateral side of the first receptacle and providing tensioned connection of the second lateral side of the first receptacle to a second structure of the center console of the vehicle.

6. The device of claim 5, wherein:
the first lateral stabilizer is adjustably positionable relative to the first lateral side of the first receptacle; and
the second lateral stabilizer is adjustably positionable relative to the second lateral side of the first receptacle.

7. The device of claim 5, wherein:
the first stabilizer has a first hook connected to a first cord that is connected to a first automatic cord retractor; and
the second stabilizer has a second hook connected to a second cord that is connected to a second automatic cord retractor.

8. The device of claim 7, wherein:
the first hook of the first stabilizer is configured for attachment to a first air vent structure of the center console of the vehicle; and
the second hook of the second stabilizer is configured for attachment to a second air vent structure of the center console of the vehicle.

9. A device for holding various accessories or items within a vehicle and proximate to a driver of the vehicle, the device comprising:
a first receptacle defining a first compartment for holding accessories or items;
a second receptacle defining a second compartment for holding accessories or items;
a rod made from a bendable and shape-retainable material, the rod having a first hook on an upper end thereof that is connectable to a rear view mirror mount of the vehicle; and
a connector attached to a rear wall of the first receptacle and to the rod so as to allow adjustable movement of the rod relative to the connector to change position of the first and second receptacles relative to the rod.

10. The device of claim 9, wherein the second receptacle extends from a front wall of the first receptacle.

11. The device of claim 10, wherein the connector comprises a biasing member that is naturally biased into a holding position with respect to the rod and which, when unbiased through manual manipulation, allows the movement of the rod relative to the biasing member.

12. The device of claim 11, wherein the biasing member comprises a strap made from a resilient material and having an upper aperture and a lower aperture, the strap connected to the rear wall of the first receptacle at a point between the first and second apertures, the rod extending through the upper and lower apertures.

13. The device of claim 12, wherein the rod further has a second hook on a lower end thereof that is below the second aperture of the strap, the second hook preventing the rod from coming free of the strap.

14. The device of claim 12, further comprising:
a first lateral stabilizer adjustably mounted to a first lateral side of the first receptacle and providing tensioned connection of the first lateral side of the first receptacle to a first structure of a center console of the vehicle; and
a second stabilizer adjustably mounted to a second lateral side of the first receptacle and providing tensioned connection of the second lateral side of the first receptacle to a second structure of the center console of the vehicle.

15. The device of claim 14, wherein:
the first stabilizer has a first hook connected to a first cord that is connected to a first automatic cord retractor; and
the second stabilizer has a second hook connected to a second cord that is connected to a second automatic cord retractor.

16. The device of claim 15, wherein:
the first hook of the first stabilizer is configured for attachment to a first air vent structure of the center console of the vehicle; and
the second hook of the second stabilizer is configured for attachment to a second air vent structure of the center console of the vehicle.

17. An accessory receptacle for holding various items within a vehicle and proximate to a driver of the vehicle, the device comprising:
a main receptacle defining an open-topped main compartment of a first size for holding items;
a secondary receptacle defining an open-topped secondary compartment of a second size that is smaller than the first size of the main compartment for holding items, the secondary receptacle extending from a front wall of the main receptacle;
a flexible rod made from a bendable and shape-retainable material, the flexible rod having a first hook on an upper end thereof that is connectable to a rear view mirror mount of the vehicle; and
a connector attached to a rear wall of the first receptacle and to the flexible rod so as to allow adjustable movement of the flexible rod relative to the connector to change position of the first and second receptacles relative to the flexible rod.

18. The device of claim 17, wherein the connector comprises a biasing member that is naturally biased into a holding position with respect to the flexible rod and which, when unbiased through manual manipulation, allows the movement of the flexible rod relative to the biasing member.

19. The device of claim 18, wherein the biasing member comprises a strap made from a resilient material and having an upper aperture and a lower aperture, the strap connected to the rear wall of the first receptacle at a point between the first and second apertures, the flexible rod extending through the upper and lower apertures.

20. The device of claim 19, further comprising:
a first lateral stabilizer adjustably mounted to a first lateral side of the first receptacle and providing tensioned connection of the first lateral side of the first receptacle to a first structure of a center console of the vehicle; and
a second stabilizer adjustably mounted to a second lateral side of the first receptacle and providing tensioned connection of the second lateral side of the first receptacle to a second structure of the center console of the vehicle.
